(19) United States
(12) Patent Application Publication
(10) Pub. No.: US 2010/0235839 A1
(43) Pub. Date: Sep. 16, 2010

(54) APPARATUS AND METHOD FOR AUTOMATION OF A BUSINESS PROCESS

(75) Inventors: Xuenian Hu, Singapore (SG); Ren Jie New, Singapore (SG)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 12/625,927

(22) Filed: Nov. 25, 2009

(30) Foreign Application Priority Data
Mar. 10, 2009 (SG) 200901684-1

(51) Int. Cl. G06F 9/46; G06Q 10/00; G06F 17/24

(52) U.S. Cl. 718/100; 705/348; 715/272

(57) ABSTRACT

An apparatus for automation of a business process, the business process comprising a plurality of tasks. The apparatus comprises a diagram editor for creating and editing a business process diagram, the business process diagram including the plurality of tasks. The apparatus also comprises an implementation editor for creating and editing an implementation of at least one of the plurality of tasks in the business process diagram, the implementation comprising a number of activities. The business process diagram and the implementation together form an executable business process definition.

### FIELD OF THE INVENTION

The invention relates to an apparatus and method for business process management and particularly, though not exclusively, relates to automation of a business process.

### BACKGROUND

Business processes or procedures are basic elements of operation of modern organizations. Business process management is therefore critical towards an organization's efficiency and quality, particularly when a business process interacts with IT applications and tools such that automation of the business process is made possible.

Automation of a business process typically comprises four different phases, namely: 1) Definition, Design & Modeling; 2) Development & Deployment, 3) Management & Monitoring, and 4) Analysis & Optimization.

In the first phase of Definition, Design & Modeling, the business process is normally designed and documented as a workflow of a plurality of tasks. Documentation of the workflow typically involves using a proprietary flowchart creation software (e.g. SmartDraw®, Microsoft Visio) to depict the business process on paper or on a computer screen in the form of blocks and arrows, based on business logic requirements. Specific notes may be added to qualify the function of each block.

Documentation of the workflow is usually performed by business analysts, i.e., people who take care of that business process and are familiar with the plurality of tasks that make up that business process. For example, leave application for staff of a company may be considered a business process that comes under a human resource department of that company. Consequently, the business process of leave application would normally be documented by someone such as a human resource officer. The plurality of tasks in a leave application workflow may comprise: 1) submission of a leave application request by a staff member of the company to his reporting officer, 2) decision making by the reporting officer, and 3) notification of the reporting officer's decision to the human resource department and to the staff member. The documented leave application workflow would consequently depict the three tasks mentioned above as three respective blocks appropriately connected with arrows.

In the second phase of Development & Deployment, the documented workflow has to be realised by way of interaction between one or more systems that constitute an IT infrastructure of an organization. This is typically achieved by creating executable processes towards part or full automation of the various activities that are involved when implementing each of the plurality of tasks that make up the business process. Executable processes may be software artifacts that can also be graphically represented in order to serve as input for execution by a business process execution module. Executable processes defined in this manner may be referred to as service orchestration, meaning scripting a new service as a function of other services.

Using the leave application example mentioned above, service orchestration of the first task in a leave application, i.e. submission of a leave application request by a staff member of the company to his reporting officer, may involve a number of activities in the form of executable processes, such as: i) launching a leave application software module, ii) selecting the name of the staff member, iii) selecting leave dates, iv) saving the leave application, v) transmitting the leave application request to the reporting officer in the form of a pending decision.

Creation of executable processes from the documented workflow thus often requires programming skills and extensive understanding of the conventions adopted by various proprietary software products designed for this purpose. It is therefore normally performed by IT engineers since the business analysts (such as a human resource officer) who documented the workflow are usually not trained in programming or implementing business tasks as specific activities using software.

Creation of executable processes from the documented workflow also involves migration of the documented workflow to the proprietary software products for implementation of the business tasks, since different proprietary software products are provided for workflow documentation and for creating executable processes.

Automation of a business process is therefore traditionally a time-consuming, costly and resource intensive exercise. It involves people from different disciplines and departments having to ensure smooth transfer and application of their know-how between software platforms, thereby increasing management costs resulting from skill barriers and/or limited availability of specialists. Communication gaps may also arise during transfer or migration from the documented workflow to the creation of executable processes, thereby compromising the quality of fit between business workflow design and implementation.

### SUMMARY OF THE INVENTION

According to a first exemplary aspect, there is provided an apparatus for automation of a business process, the business process comprising a plurality of tasks. The apparatus comprises a diagram editor for creating and editing a business process diagram, the business process diagram including the plurality of tasks. The apparatus also comprises an implementation editor for creating and editing an implementation of at least one of the plurality of tasks in the business process diagram, the implementation comprising a number of activities. The business process diagram and the implementation together form an executable business process definition.

The apparatus may further comprise a repository for storing the business process definition therein, an execution module for executing the business process definition, and/or a monitoring and control module for monitoring and controlling execution of the business process definition by the execution module.

The implementation editor is preferably further for setting up additional configurations.

The diagram editor may comprise a diagram canvas and selectable diagram primitives for building the business process diagram on the diagram canvas.

The implementation editor may comprise an implementation canvas and selectable implementation primitives for building the implementation of the at least one of the plurality of tasks in the business process diagram on the implementation canvas.

The apparatus may further comprise at least one user console for providing access to the diagram editor and to the implementation editor.

According to a second exemplary aspect, there is provided a method of automation of a business process, the business process comprising a plurality of tasks. The method comprises creating a business process diagram using a diagram editor in a business process automation apparatus, the business process diagram including the plurality of tasks. The method also comprises creating an implementation of at least one of the plurality of tasks in the business process diagram using an implementation editor in the business process automation apparatus; such that the business process diagram and the implementation together form an executable business process definition.

The method may further comprise checking a repository in the business process automation apparatus for an existing business process definition prior to creating the business process diagram, storing the executable business process definition in the repository, executing the business process definition using an execution module in the business process automation apparatus, monitoring and controlling execution of the business process definition using a monitoring and control module in the business process automation apparatus, and/or setting up additional configurations using the implementation editor.

Creating the business process diagram may comprise using selectable diagram primitives to build the business process diagram on a diagram canvas in the diagram editor.

Creating the implementation may comprise using selectable implementation primitives to build the implementation of the at least one of the plurality of tasks in the business process diagram on the implementation canvas in the implementation editor.

The method may further comprise providing access to the diagram editor and to the implementation editor through at least one user console in the business process automation apparatus.

### BRIEF DESCRIPTION OF THE DRAWINGS

In order that the invention may be fully understood and readily put into practical effect there shall now be described by way of non-limitative example only exemplary embodiments of the present invention, the description being with reference to the accompanying illustrative drawings.

In the Drawings:

FIG. 1 is an architecture diagram of an exemplary apparatus for automation of a business process;

FIG. 2 is a flow chart of an exemplary method of automation of a business process;

FIG. 3 is a schematic view of an exemplary screenshot of a diagram editor of the exemplary apparatus of FIG. 1; and

FIG. 4 is a schematic view of an exemplary screenshot of an implementation editor of the exemplary apparatus of FIG. 1.

### DETAILED DESCRIPTION OF THE EXEMPLARY EMBODIMENTS

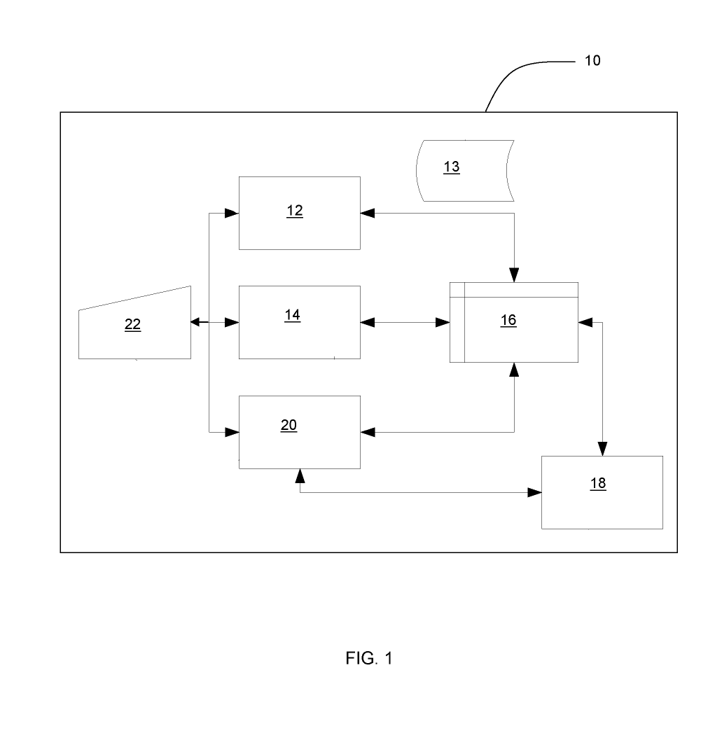

An exemplary apparatus for automation of a business process is shown in FIG. 1. The business process typically comprises a plurality of tasks that are linked together as a to business process workflow.

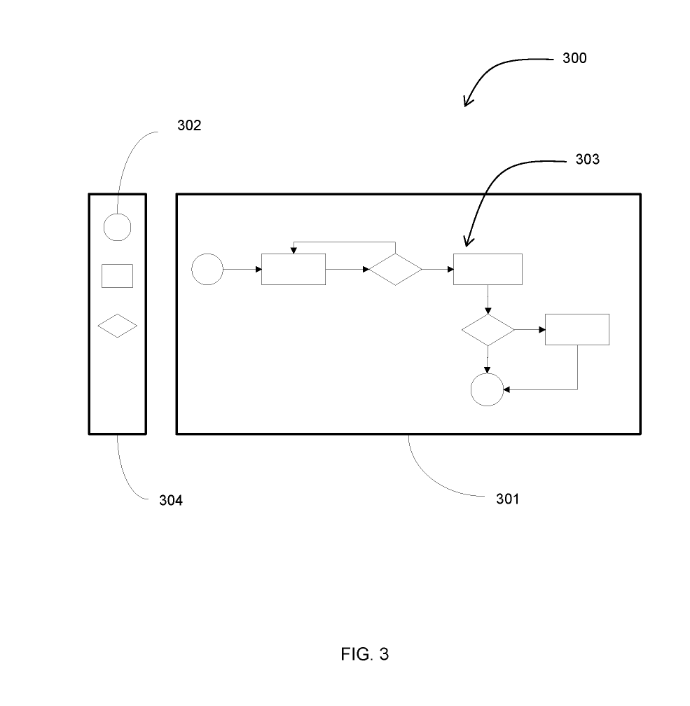

The apparatus 10 comprises a business process diagram editor 12 for creating and editing a business process diagram from the workflow. An exemplary screenshot 300 of the diagram editor 12 is shown in FIG. 3, The diagram editor 12 preferably comprises a diagram canvas 301 and selectable diagram primitives 302 for building the business process diagram 303 on the diagram canvas 301.

The diagram primitives 302 are preferably displayed within a toolbox 304 for selection by a user. The diagram primitives 302 preferably include conventional flowcharting elements such as a rectangular box for action, a diamond box for decision, a circular box for wait, and so on, such that each element may be used to represent each of the plurality of tasks in the business process workflow. Preferably, standard industrial notations such as BPMN2.0 are followed. The diagram primitives 302 preferably also include connecting arrows for appropriately linking together the flowchart elements representing the plurality of tasks in the work flow. Using a mouse, a user may thus simply “drag-and-drop” appropriate diagram primitives 302 onto the diagram canvas 301 to build the business process diagram 303 comprising the plurality of tasks.

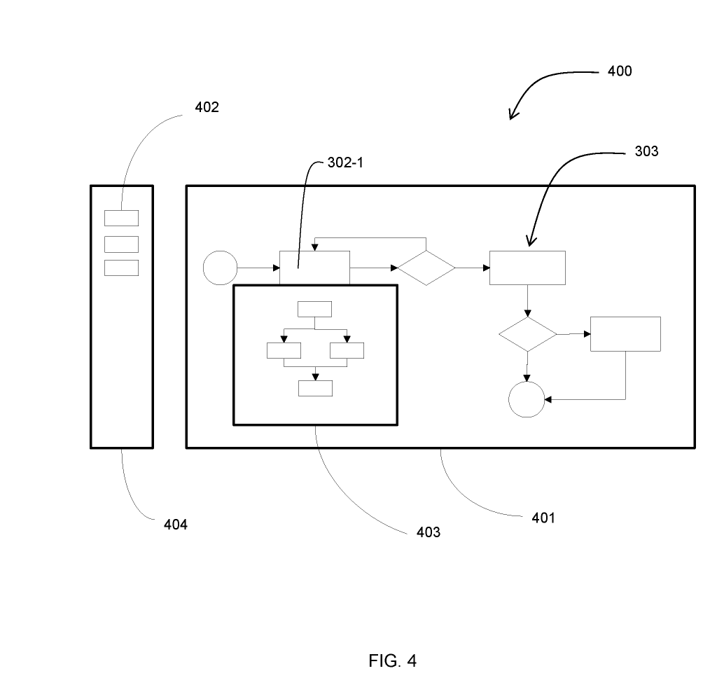

Besides the diagram editor 12, the apparatus 10 also comprises an implementation editor 14 for creating and editing an implementation of at least one of the plurality of tasks in the business process diagram 303. The implementation of a task normally comprises a number of activities that should be organized like a block of program statements. FIG. 4 shows an exemplary screenshot 400 of the implementation editor 14 which uses a graphical model to represent an execution logic of a task 302-1 and to declare or specify a series of steps that are to be executed in a prescribed order for that task 302-1. In an exemplary embodiment, the implementation editor 14 may be launched or brought up from the diagram canvas 301 by a mouse double-click on a task 302-1 to be implemented.

The implementation editor 14 preferably comprises an implementation canvas 401 and selectable implementation primitives 402 for building the implementation 403 of at least one of the plurality of tasks 302-1 in the business process diagram 303 on the implementation canvas 401. The implementation primitives 402 preferably include conventional application integration blocks, such as invoking web services and sending notifications via email, or domain specific integration blocks, and so on, wherein each element may be used to represent each of the number of activities that are involved in the implementation 403 of the task 302-1 in the business process diagram 303.

The implementation primitives 402 preferably also determine an execution flow, and within the execution flow, flow of control is defined with structure implementation primitives such as sequential, if-else branching and while loops. Using a mouse, a user may thus simply “drag-and-drop” appropriate implementation primitives 402 onto the implementation canvas 401. In this way, an implementation 403 comprising a number of activities may be created for each of the plurality of tasks 302-1 where required. Preferably, reputed and industry standard scripting versions of programming languages like VB.net and C# are provided in the implementation editor 14, thereby reducing the skill barrier required for creating implementations 403.

The business process diagram 303 together with the implementation of at least one, and preferably all, of the plurality of tasks together form an executable business process definition 13.

The apparatus 10 is preferably configured to allow the executable business process definition 13 to be stored or saved in a repository 16. In this way, the business process definition 13 may be retrieved for subsequent use, or for editing by the diagram editor 12 or the implementation editor 14.

The apparatus 10 preferably also comprises an execution module 18 for executing the business process definition 13. The execution module 18 may be installed in a backend server, only retrieving the business process definition 13 from the repository 16 for execution when necessary.

The apparatus 10 may further include a monitoring and control module 20 for monitoring and controlling the execution of the business process definition 13 that is performed by the execution module 18. Granularity offered by the monitoring and control module 20 in monitoring the activities and tasks under execution enhances their clarity and action.

In case of failure of any interacting components of a business process, the apparatus 10 is further configured to allow users having the requisite access privilege or right to reroute the path of the business process using either the diagram editor 12 or the implementation editor 14 as appropriate.

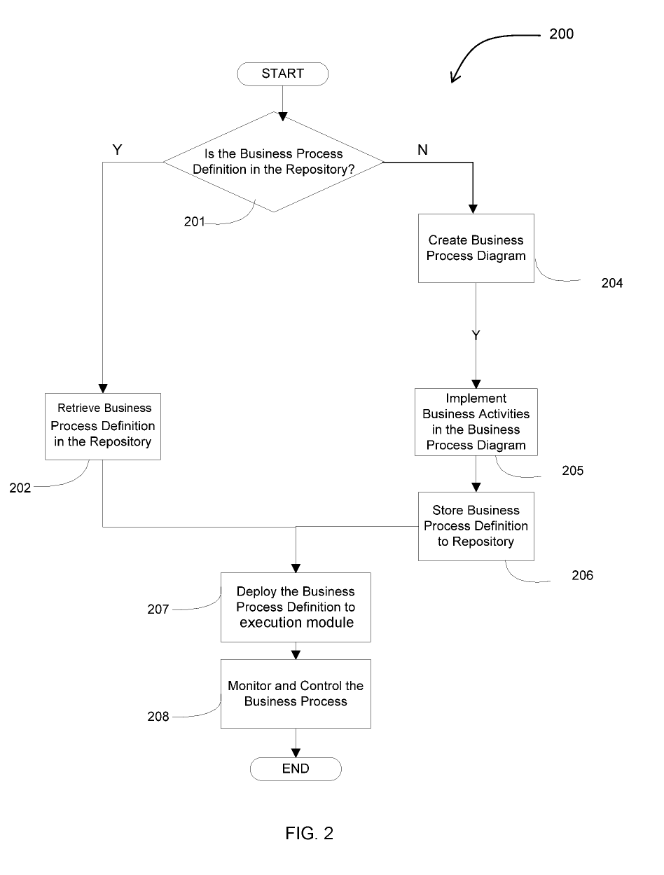

An exemplary method 200 using the apparatus 10 is shown in FIG. 2. Upon starting, it may be preferred to check the repository 16 whether an appropriate business process definition 13 is already stored therein that is suitable for use 201. If yes, the appropriate business process definition 13 is retrieved from the repository 16, 202 and deployed or executed 207 using the execution module 18. If no appropriate business process definition 16 is found in the repository, a business process diagram is then created 204 using the diagram editor 12. This will typically be done by one or more business analysts.

After the business process diagram is created, an implementation of at least one of the plurality of tasks in the business process diagram is then created 205 using the implementation editor. This is usually performed by one or more IT engineers, who normally would together create implementations for all the tasks in the business process diagram, where necessary. The business process diagram and the implementation(s) together from a new business process definition 13 that is preferably stored to the repository 16, 206, followed by deployment or execution 207 by the execution module 18 as required. Execution of the business process definition may further be monitored and controlled 208 by the monitoring and control module 20.

Preferably, the apparatus 10 comprises at least one user console 22 through which access to the diagram editor 12, the implementation editor 14 may be provided. The same user console 22 may also provide access to the monitoring and control module 20.

The apparatus 10 may be enhanced by providing industry-specific business process templates to simplify and speed up the creation of business process diagrams and implementations. Business process analytics may also be provided, such as cycle time tracking for business process performance or other statistics. In this way, the apparatus 10 can be used to provide baselines and allow benchmarking, optimization and/or measurements in improvements of a business process over a period of time or over a number of executions.

By providing a single apparatus 10 for creating a business process diagram 204 comprising a plurality of tasks and for creating the implementation 205 of each task comprising a number of activities, diverse requirements of the business analysts and the IT engineers may be unified. Different groups of users can use the apparatus 10 and method 200 at different phases of automation of the business process. The apparatus 10 provides a tool for business analysts to define and document business processes in the form of business process diagrams 303, while at the same time also provides a tool for IT engineers to implement the business tasks that interact with IT applications. The joint output of the business analysts and IT engineers in the form of a business process definition 13 thus becomes an input to a runtime engine or execution module 18 provided by the apparatus 10 for automation execution.

By providing a unified apparatus 10, communication between business analysts and IT engineers may be sped up. The apparatus 10 also allows the business analysts to easily publish a business process after creating/editing the business process diagram using the diagram editor 12.

Whilst there has been described in the foregoing description exemplary embodiments of the present invention, it will be understood by those skilled in the technology concerned that many variations in details of design, construction and/or operation may be made without departing from the present invention. For example, a plurality of user consoles 22 may be provided so that business analysts and IT engineers may concurrently use the apparatus 10 to work on automating one or more business processes at a time.

1. An apparatus for automation of a business process, the business process comprising a plurality of tasks, the apparatus comprising:
a diagram editor for creating and editing a business process diagram, the business process diagram including the plurality of tasks; and
an implementation editor for creating and editing an implementation of at least one of the plurality of tasks in the business process diagram, the implementation comprising a number of activities;
wherein the business process diagram and the implementation together form an executable business process definition.

2. The apparatus of claim 1, further comprising a repository for storing the business process definition therein.

3. The apparatus of claim 1, further comprising an execution module for executing the business process definition.

4. The apparatus of claim 3, further comprising a monitoring and control module for monitoring and controlling execution of the business process definition by the execution module.

5. The apparatus of claim 1, wherein the implementation editor is further for setting up additional configurations.

6. The apparatus of claim 1, wherein the diagram editor comprises a diagram canvas and selectable diagram primitives for building the business process diagram on the diagram canvas.

7. The apparatus of claim 1, wherein the implementation editor comprises an implementation canvas and selectable implementation primitives for building the implementation of the at least one of the plurality of tasks in the business process diagram on the implementation canvas.

8. The apparatus of claim 1, further comprising at least one user console for providing access to the diagram editor and to the implementation editor.

9. A method of automation of a business process, the business process comprising a plurality of tasks, the method comprising:
creating a business process diagram using a diagram editor in a business process automation apparatus, the business process diagram including the plurality of tasks; and
creating an implementation of at least one of the plurality of tasks in the business process diagram using an implementation editor in the business process automation apparatus;
such that the business process diagram and the implementation together form an executable business process definition.

10. The method of claim 9, further comprising checking a repository in the business process automation apparatus for an existing business process definition prior to creating the business process diagram.

11. The method of claim 10, further comprising storing the executable business process definition in the repository.

12. The method of claim 9, further comprising executing the business process definition using an execution module in the business process automation apparatus.

13. The method of claim 12, further comprising monitoring and controlling execution of the business process definition using a monitoring and control module in the business process automation apparatus.

14. The method of claim 9, further comprising setting up additional configurations using the implementation editor.

15. The method of claim 9, wherein creating the business process diagram comprises using selectable diagram primitives to build the business process diagram on a diagram canvas in the diagram editor.

16. The method of claim 9, wherein creating the implementation comprises using selectable implementation primitives to build the implementation of the at least one of the plurality of tasks in the business process diagram on the implementation canvas in the implementation editor.

17. The method of claim 9, further comprising providing access to the diagram editor and to the implementation editor through at least one user console in the business process automation apparatus.
